(19) United States
(12) Patent Application Publication
(10) Pub. No.: US 2020/0201935 A1
(43) Pub. Date: Jun. 25, 2020

(54) CENTRALIZED RENDERING SERVICE FOR A REMOTE NETWORK MANAGEMENT PLATFORM

(71) Applicant: ServiceNow, Inc., Santa Clara, CA (US)

(72) Inventors: Josip Filipovic, Amsterdam (NL); Oriol Arbones, Amsterdam (NL); Ciprian Mocanu, Amsterdam (NL); Andrei-Mihai Gabur, Almere (NL); Benedetto Fiorelli, Amsterdam (NL)

(73) Assignee: ServiceNow, Inc., Santa Clara, CA (US)

(21) Appl. No.: 16/228,216

(22) Filed: Dec. 20, 2018

(51) Int. Cl. G06F 17/22; G06T 1/20; G06T 11/20; H04L 12/24

(52) U.S. Cl. CPC G06F 17/227; G06T 1/20; H04L 67/02; G06T 11/206; H04L 41/22; G06F 17/2247

(57) ABSTRACT

A computing system may include computational instances of a remote network management platform, and a central computational instance of the remote network management platform. The central computational instance may provide a chart rendering service configured to: receive, from a computing device of one of the computational instances, a request including (i) data that defines a chart, and (ii) a uniform resource locator (URL) associated with the chart rendering service; based on the URL, route the data to a rendering pipeline; acquire a worker thread from a worker thread pool; based on a pre-determined configuration of the rendering pipeline, the worker thread: (i) rendering the data to a graphical representation of the chart, and (ii) exporting the graphical representation of the chart to an output file and in an output file format; and transmit, to the computing device, the output file.

### BACKGROUND

Chart rendering can be an important feature provided by enterprise software. An enterprise may use various types of charts (e.g., line charts, bar charts, pie charts, etc.) to track progress of projects, information technology (IT) service requests, web site traffic, and other key performance indicators (KPIs). Being able to visualize these KPIs in dashboards and other formats can be helpful in ensuring that the enterprise is achieving its goals, or determining the source of problems when the enterprise is not achieving its goals.

### SUMMARY

When an enterprise uses a remote network management platform to manage its network, the remote network management platform may provide chart rendering services. For example, an independent rendering engine could be deployed in each computational instance of the remote network management platform, where these computational instances are dedicated to different managed networks. However, this would require using processing and memory resources for the rendering engine in each computational instance.

A more efficient deployment scenario would entail the rendering engine being placed in a central instance of the remote network management platform. While such a centralized rendering engine would save resources on the other computational instances, it could become a bottleneck when it receives a large number of rendering requests. Also, there is a concern that confidential or private information of a computational instance might be inadvertently stored in the rendering engine after the corresponding request is served.

In order to provide an efficient centralized rendering engine, the embodiments herein employ an architecture that uses a pool of worker threads on the central instance to serve rendering requests. Based on the type or nature of the request (e.g., JavaScript Object Notation, HyperText Markup Language, etc.), the worker thread serving the request may handle it differently. In some cases, the same worker thread can be reused across multiple requests. Additionally, common information between requests can be cached and shared between by worker threads. Further, the architecture allows the setting of a limit on the number of requests each worker thread serves before it is destroyed, thus limiting the exposure of any confidential or private information in each of these requests.

Accordingly, a first example embodiment may involve a plurality of computational instances of a remote network management platform, each associated with a different managed network. The first example embodiment may also involve a central computational instance of the remote network management platform. The central computational instance may provide a chart rendering service to the plurality of computational instances. The chart rendering service may be configured to: receive, from a computing device of one of the plurality of computational instances, a request including (i) data that defines a chart, and (ii) a uniform resource locator (URL) associated with the chart rendering service; based on the URL, route the data to a rendering pipeline; acquire a worker thread from a worker thread pool; based on a pre-determined configuration of the rendering pipeline, the worker thread: (i) rendering the data to a graphical representation of the chart, and (ii) exporting the graphical representation of the chart to an output file and in an output file format; dispose of the worker thread; and transmit, to the computing device, the output file.

A second example embodiment may involve: receiving, by a chart rendering service executing on a central computational instance disposed within a remote network management platform, a request including (i) data that defines a chart, and (ii) a URL associated with the chart rendering service, where the request is from a computing device of one of a plurality of computational instances disposed within the remote network management platform. The second example embodiment may also involve, possibly based on the URL, routing, by the chart rendering service, the data to a rendering pipeline. The second example embodiment may also involve acquiring, by the chart rendering service, a worker thread from a worker thread pool. The second example embodiment may also involve, possibly based on a pre-determined configuration of the rendering pipeline, the worker thread: (i) rendering the data to a graphical representation of the chart, and (ii) exporting the graphical representation of the chart to an output file and in an output file format. The second example embodiment may also involve disposing, by the chart rendering service, of the worker thread. The second example embodiment may also involve transmitting, by the chart rendering service and to the computing device, the output file.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts a definition of a chart in JavaScript Object Notation, in accordance with example embodiments.

FIG. 6B depicts a rendered chart, in accordance with example embodiments.

FIG. 7 depicts a rendering engine within a central instance of a remote network management platform, in accordance with example embodiments.

FIG. 8A depicts a procedure for routing and processing of chart rendering requests, in accordance with example embodiments.

FIG. 8B depicts a procedure for releasing computational resources after chart rendering, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

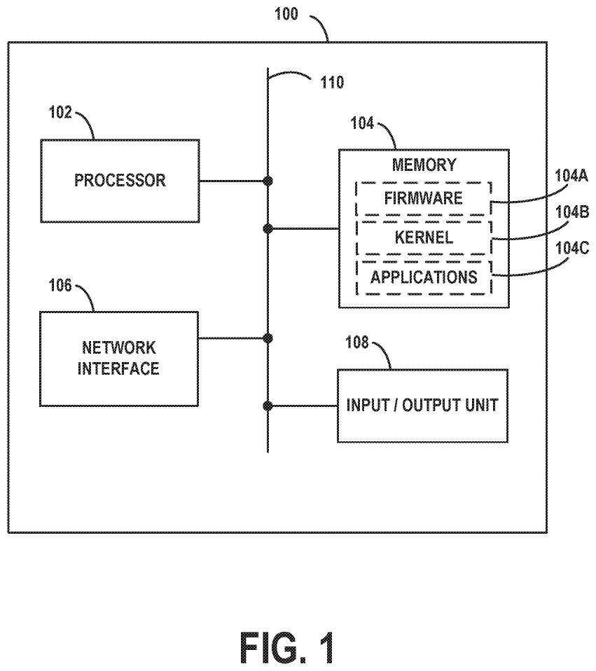

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

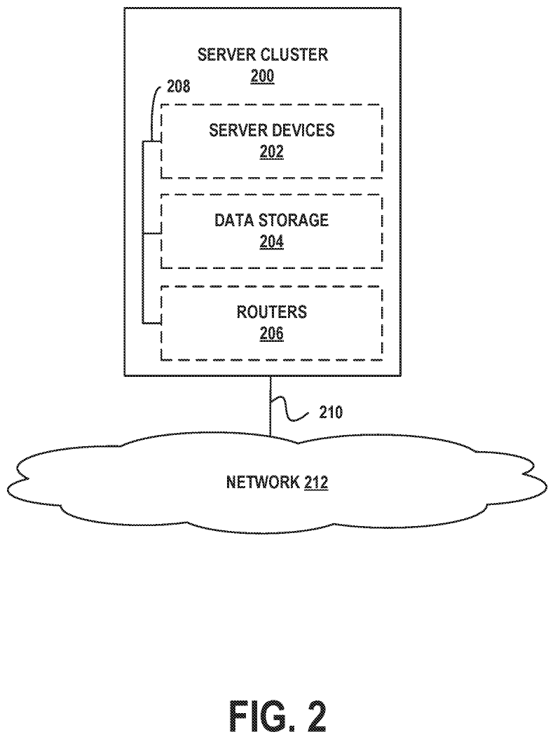

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. EXAMPLE REMOTE NETWORK MANAGEMENT ARCHITECTURE

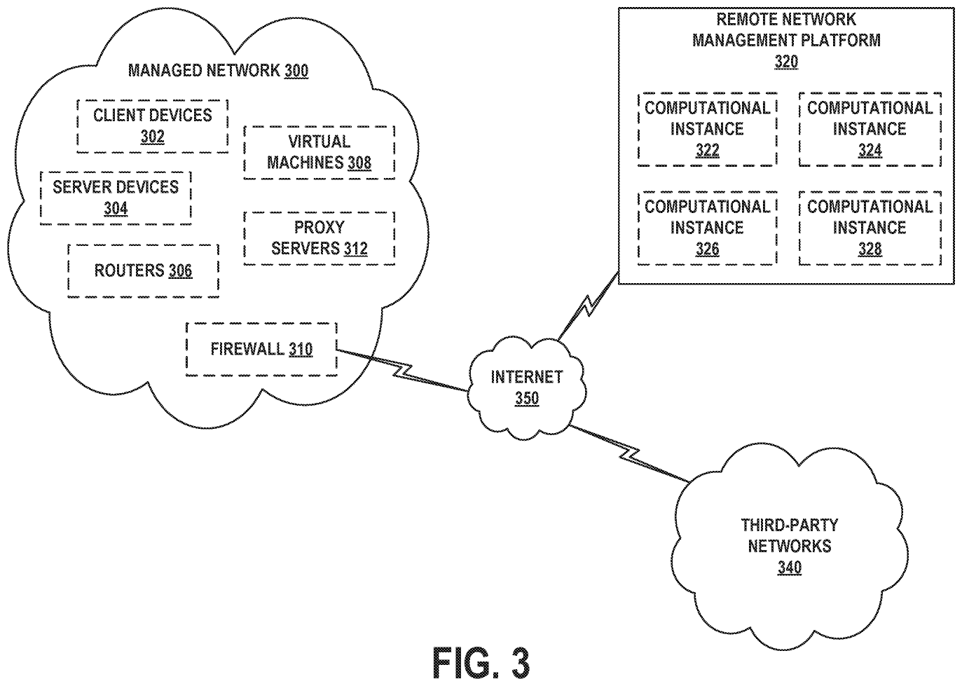

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent one or more server devices and/or one or more databases that provide a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows with one or more database tables).

For purpose of clarity, the disclosure herein refers to the physical hardware, software, and arrangement thereof as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are commingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents commingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of physical or virtual servers and database devices. Such a central instance may serve as a repository for data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

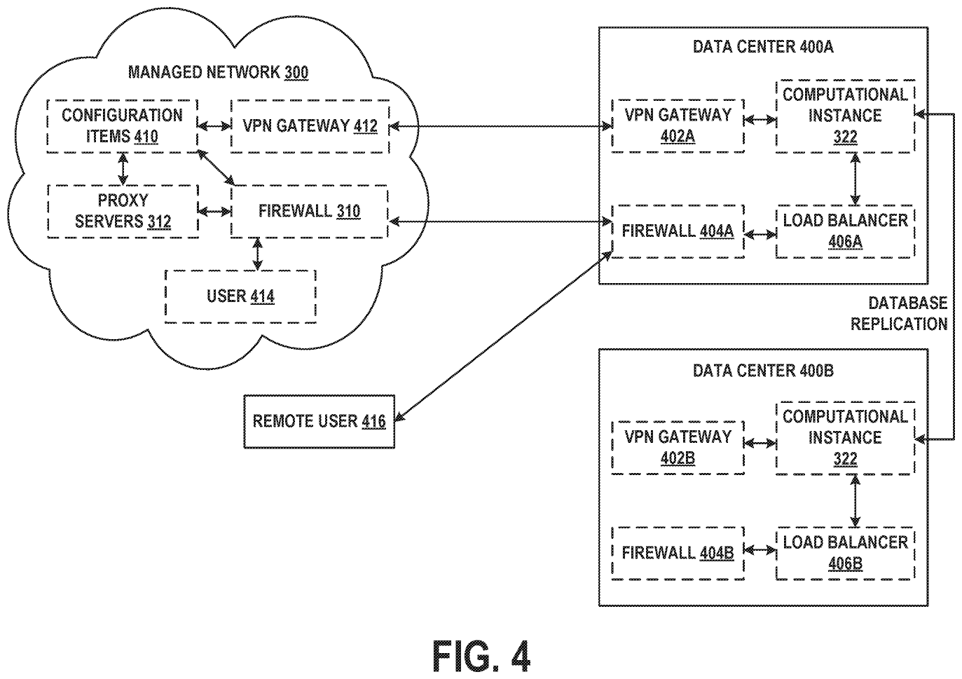

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

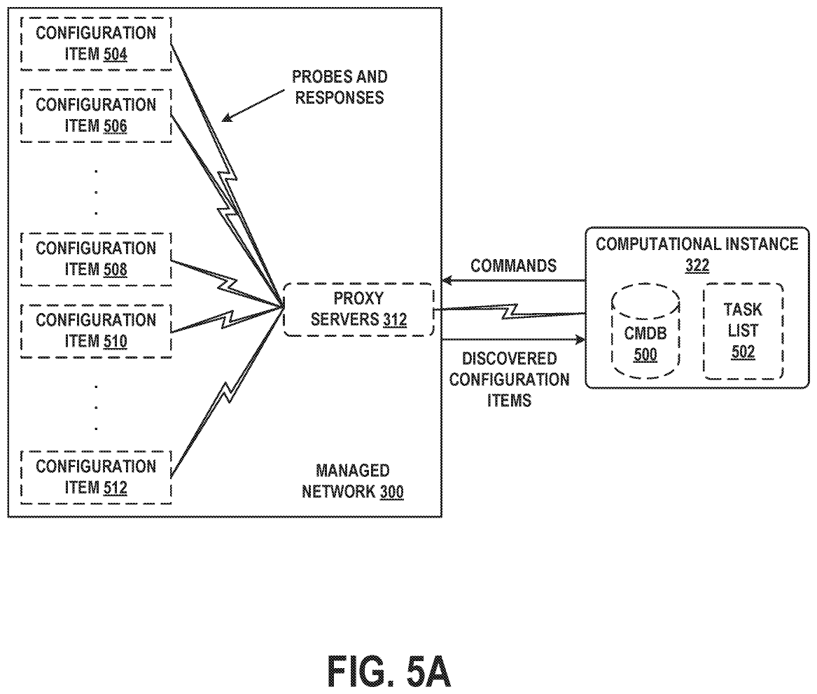

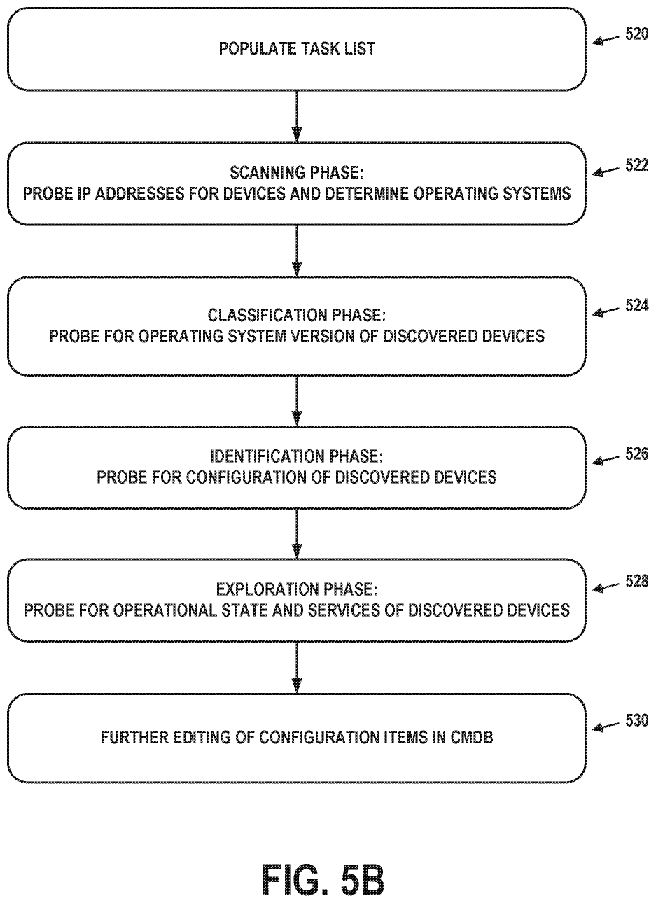

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. RENDERING ENGINES AND ARCHITECTURES

Chart rendering can be an important feature of a remote network management platform. Managed networks may use their respective computational instances to track progress of projects, IT service requests, web site traffic, and other key performance indicators (KPIs) of their enterprises. Being able to visualize these KPIs in dashboards and other formats can be helpful in ensuring that the enterprise is achieving its goals, or determining the source of problems when the enterprise is not achieving its goals. Thus, there are many possible uses for charts in a remote network management platform.

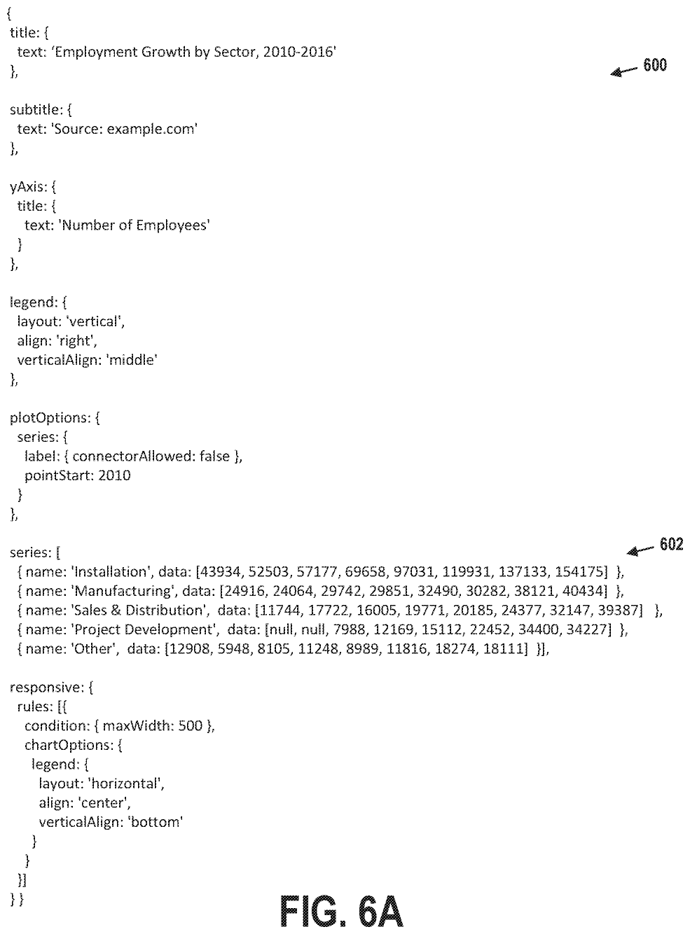

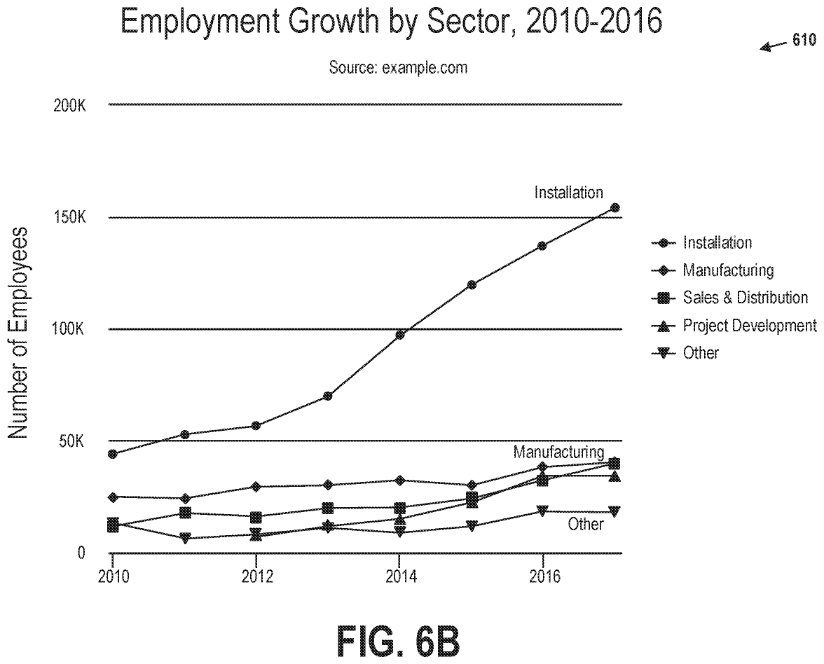

FIG. 6A depicts source data 600 for an example chart 610, and FIG. 6B depicts a rendering of example chart 610. Source data 600 is encoded in JavaScript Object Notation (JSON), and specifies a title, subtitle, y-axis label, one x-axis label per data set, and various other formatting parameters. The “series” object 602 contains each point to plot on the graph for the data sets. Example chart 610 reflects these specifications.

Notably, JSON is not the only possible input format for chart rendering. Other formats, such as HTML, or a combination of one or more of HTML, JavaScript, cascading style sheets (CSS), and comma-separated values (CSV) could be used instead or as well. Further, the output of the rendering may take various forms, including a graphics file such as a Joint Photographic Experts Group (JPEG) file, a Portable Network Graphics (PNG) file, a Portable Document Format (PDF) file, and so on. Additionally, while example chart 610 is a line chart, other chart formats could be used, such as a bar chart, histogram, pie chart, area chart, scatter plot, or heat map.

Deploying a rendering engine that could, for example, take source data 600 and produce example chart 610, has challenges that are unique to a remote network management platform. In one scenario, an independent rendering engine could be deployed in each computational instance of the remote network management platform. However, this would require using processing and memory resources for the rendering engine in each computational instance. Furthermore, this would be another computational instance module that the users of the associated managed network would have to learn to configure and manage.

A more efficient deployment scenario would entail the rendering engine being placed in a central instance of the remote network management platform. As noted above, such a central instance is managed and controlled by the entity that provides the remote network management platform rather than each of the managed networks. While such a centralized rendering engine would save resources on the other computational instances, it could become a bottleneck when it receives a large number of rendering requests. Also, there is a concern that confidential or private information of a computational instance might be inadvertently stored in the rendering engine after the corresponding request is served.

In order to provide an efficient centralized rendering engine, the embodiments herein employ an architecture that uses a pool of worker threads on the central instance to serve rendering requests. Based on the type or nature of the request (e.g., JSON, HTML, etc.), the worker thread serving the request may handle it differently. In some cases, the same worker thread can be reused across multiple requests. Additionally, common information between requests can be cached and shared between by worker threads. Further, the architecture allows the setting of a limit on the number of requests each worker thread serves before it is destroyed, thus limiting the exposure of any confidential or private information in each of these requests.

While there are many ways of developing such a rendering engine, in terms of programming languages and frameworks, the illustrative examples herein utilize a server-side JavaScript interpreter along with a “headless” web browser (e.g., a web browser without a graphical user interface that is controllable by way of an application programming interface). The server-side JavaScript interpreter controls the overall processing and routing of the requests, while the headless web browser provides the worker thread pool (in the form of non-viewable “tabs”) and performs at least some of the rendering.

Further, each worker thread may employ a different type of renderer based on what is specified in the request (e.g., the URL of the request). For instance, some requests may go to open-source, commercial, or third-party renderers, while others may be handled by a renderer provided by the remote network management platform. The renderers create the graphics file (e.g., JPEG, PNG, or PDF) of the chart. Each of these renders may be implemented as a logical path or pipeline through the rendering engine with their respective URLs as entry points, and (as noted above) may be associated with different worker thread behavior.

An example of a server-side JavaScript interpreter is NODE.JS®, an example of a headless web browser is CHROMIUM®, and an example renderer is HIGHCHARTS®. But the embodiments herein are not limited to just these components and other components may be used.

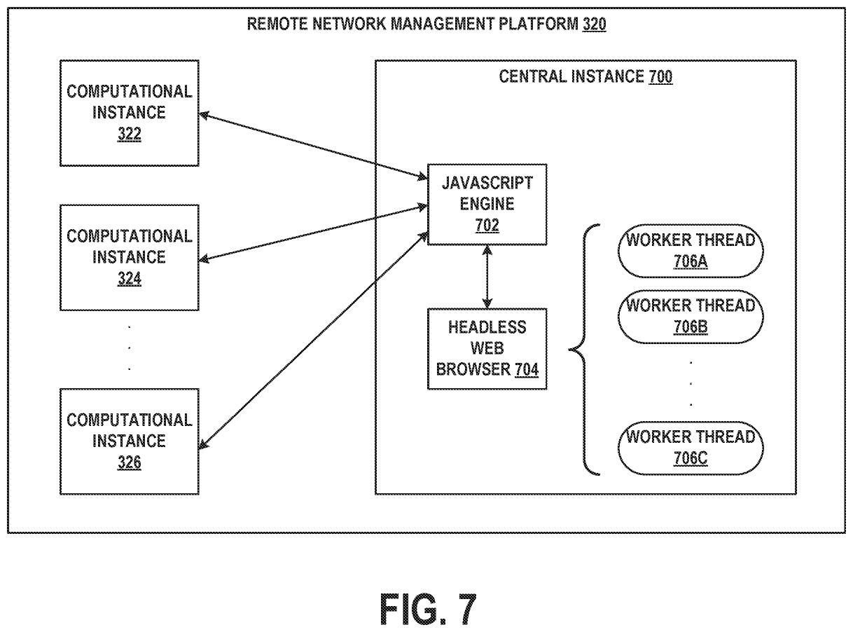

FIG. 7 provides an example architecture of a rendering engine deployed on a central instance. Similar to FIG. 3, remote network management platform 320 includes computational instances 322, 324, and 326. For sake of illustration, it is assumed that each of these computational instances is associated with a different managed network and therefore used by different entities. More or fewer computational instances may make use of these embodiments.

Remote network management platform 320 also includes central instance 700. Central instance 700, in turn, includes JavaScript engine 702 and headless web browser 704. The latter controls a number of worker threads 706A, 706B, and 706C. More or fewer may be used in these embodiments.

As described above, a computational instance (e.g., computational instance 322) may transmit a request to JavaScript engine 702. The request may be directed to a particular URL served by JavaScript engine 702, and may contain the specification of a chart in one of several formats (e.g., JSON, HTML, etc.). The URL may be determined by the format of the specification. For example, all requests containing a JSON specification may be directed to one URL, all requests containing an HTML specification may be directed to another URL, and so on.

JavaScript engine 702 may communicate with headless web browser 704 to serve these requests. Based on the URL referenced by the request, headless web browser 704 may choose an existing worker thread to serve the request, or may create a new worker thread to serve the request. Each worker thread may be associated with or capable of executing one of the renderers. After the request is served by such a renderer, the resulting graphics file is passed back to JavaScript engine 700 and then to the requesting computational instance.

After serving the request, the worker thread may be destroyed, some or all of its data may be deleted, or other actions can be taken. For instance, a renderer may be executed or called by the worker thread, and after serving the request, the renderer may be exited, stopped, or otherwise removed from memory. Alternatively, the data provided by the request (e.g., the content of source data 600 such as a JSON file or HTML file) may be deleted from memory. In some cases, in order to avoid data leakage between computational instances, the worker thread may be destroyed.

Regardless of the mechanism used to manage worker threads, caching of common data and/or program code employed by the worker threads may also be used. Some HTML-based requests may be accompanied by references to common JavaScript and/or CSS files. These JavaScript and CSS files may be library modules that are built into the remote network management platform, and used by multiple computational instances. Once such a common file is obtained by JavaScript engine 702 or headless web browser 704, it may be maintained for some period of time so that it can be used to serve multiple requests. In this way, the overhead of obtaining the file for each request is reduced, and therefore requests can be served more rapidly using locally-stored files.

Notably, the unique characteristics of a remote network management platform make this caching possible. Such caching would not work as reliably on the Internet in general, as a request from the Internet might refer to unusually-named, improperly named, or custom JavaScript and/or CSS files. In a remote network management platform, HTML files include references to a relatively small set of JavaScript and/or CSS files that are provided by the platform. In some cases, a reference to a JavaScript or CSS file may also include a version number of that file to specify a particular variation thereof.

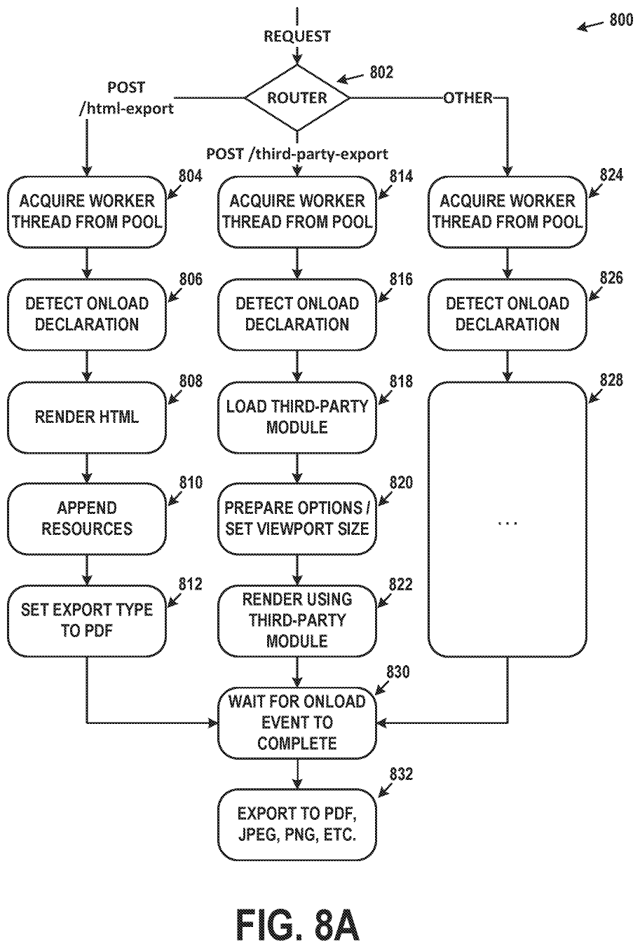

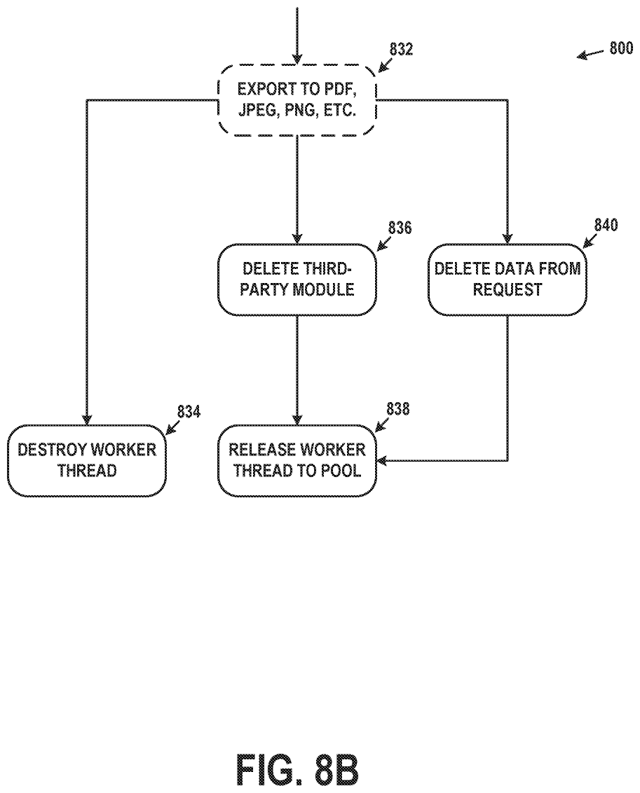

FIGS. 8A and 8B depict a procedure 800 for serving chart rendering requests by a rendering engine. JavaScript engine 702 may be an example of a rendering engine, or the combination of JavaScript engine 702 and headless web browser 704 may be viewed as a rendering engine. While procedure 800 involves a number of steps and operations, more or fewer steps or operations may be used, and the ordering of some steps and operations may be modified.

At block 802, a router of the rendering engine receives a request for rendering of a chart. The request may include a definition of a chart (e.g., as shown in FIG. 6A). The request may be directed to and/or include a URL or a partial URL that specifies an endpoint. For example, if the rendering engine is operating using TCP port 9999 of the domain name www.example.com, the rendering engine may support requests being sent to one or more endpoints that have a prefix of http://www.example.com:9999.

Each of these endpoints may be associated with a different rendering pipeline. For example, the endpoint http://www.example.com:9999/html-export may direct incoming requests to an HTML rendering pipeline, and the endpoint http://www.example.com:9999/third-party-export may direct incoming requests to a JSON rendering pipeline that incorporates a third-party rendering module. Each may be accessed by way of an HTTP POST command—in other words, the request may be an HTTP POST command with the endpoint specified in the HTTP headers and the definition of the chart specified in the HTTP body. Other examples are possible.

As noted previously, the requests may originate from client devices on one or more computational instances, each of which may be associated with different managed networks. Thus, the rendering engine is a shared service between some or all users of the remote network management platform. Based on how the chart is defined in the request (e.g., using HTML or JSON), a client device may direct the request to the appropriate endpoint. Router 802 may then route the request to the appropriate pipeline based on the URL of the endpoint.

Each pipeline assumes the existence of a worker thread pool. Each worker thread may be a thread of execution (sometimes synonymous with the terms “process” or “program”) capable of performing program instructions on the central instance. The pool may be any number of worker threads (e.g., 1, 2, 5, 10, 25, etc.) and may be managed by the rendering engine or the central instance. Thus, upon initiation, the rendering engine may create some number of worker threads to form the pool, and then select worker threads from the pool to serve incoming requests. After a request is served, its worker thread may be returned to the pool or destroyed (see FIG. 8B). This worker thread pool may help reduce or eliminate the overhead of dynamically creating a new thread to serve each incoming request.

As one possible example, FIG. 8A depicts an HTML pipeline with blocks 804, 806, 808, 810, and 812. Block 804 may involve acquiring a worker thread from the pool. Block 806 may involve detecting an onload declaration in the HTML document. An onload declaration may be JavaScript code or another type of code that defines a function to be called when the web page represented by the HTML is otherwise fully rendered. Block 808 may involve rendering the HTML. This includes formatting the HTML into a web page. Block 810 may involve appending resources to the web page. For example, if the HTML document specifies script resources or CSS resources, these may be used to modify the web page and/or the rendering thereof. Block 812 may involve setting the export file type to PDF. The use of PDF in this pipeline is for purposes of example, and other export file types could be used instead.

As another possible example, FIG. 8A also depicts a third-party pipeline with blocks 814, 816, 818, 820, and 822. For sake of illustration, it is assumed that the third-party pipeline renders requests with chart definitions encoded in JSON documents. Block 814 may involve acquiring a worker thread from the pool. Block 816 may involve detecting an onload declaration in the JSON document. Block 818 may involve loading the third-party rendering module. If the third-party rendering module is already loaded for this thread or on the central instance in general, this step may be skipped. Block 820 may involve preparing rendering options (e.g., color or black and white) and setting the viewport size (e.g., the resolution of the rendered chart). Block 822 may involve rendering the chart from the JSON document using the third-party rendering module.

Other pipelines are possible. These are represented by the “other” pipeline with blocks 824, 826, and 828. Block 824 may involve acquiring a worker thread from the pool. Block 826 may involve detecting an onload declaration in the data provided in the request. Block 828 represents other pipeline-specific processing.

Regardless of the pipeline used, block 830 may involve waiting for any onload events to complete. As noted above, onload events are invoked when the underlying document is otherwise rendered. Block 832 may involve exporting the rendered chart to PDF, JPEG, PNG, or some other file format.

Turning to FIG. 8B, procedure 800 continues. After block 832, the rendering engine determines how to dispose of the worker thread. In some embodiments, this disposal of the worker thread may be based on the pipeline selected. For instance, the HTML pipeline might always destroy the worker thread. Alternatively, any type of worker thread disposal may be used for any pipeline.

At block 834, the worker thread is destroyed. This may happen automatically, perhaps in order to clear potentially sensitive data from memory associated with the worker thread. In some embodiments, each worker thread might only be used to serve a pre-determined threshold number of requests. After a worker thread has served this number of requests, the worker thread may be destroyed. Thus, each worker thread may be associated with a count of requests that it has served, and may be destroyed when this count reaches the threshold number.

Alternatively, at block 836, the third party module that was loaded into the worker thread may be deleted from the worker thread. This also serves to clear potentially sensitive data from memory. Then, at block 838, the worker thread may be released to the thread pool.

In yet another alternative, at block 840, the data from the request (e.g., the HTML or JSON definition of the chart) is deleted. Once again, this serves to clear potentially sensitive data from memory. Then, at block 838, the worker thread may be released to the thread pool.

This multi-threaded architecture has the advantage of fast processing of individual requests, because in many cases worker threads do not need to be dynamically created and resources do not need to be retrieved from a remote device. Also, security and privacy concerns are addressed because sensitive data from one computational instance is cleared from memory before a worker thread can serve a subsequent request from another computational instance.

### VI. EXAMPLE OPERATIONS

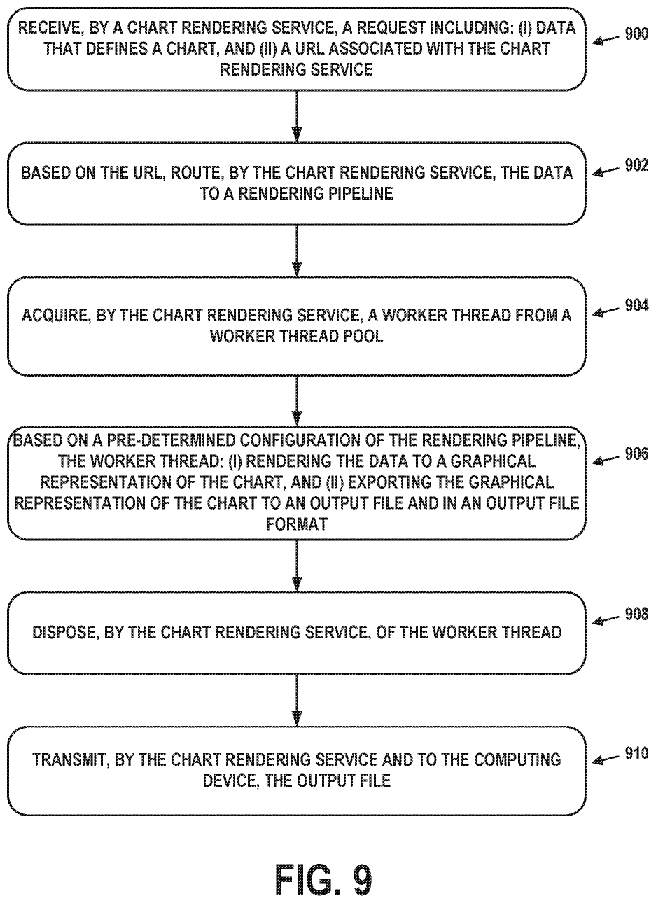

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve receiving, by a chart rendering service executing on a central computational instance disposed within a remote network management platform, a request. The request may include: (i) data that defines a chart, and (ii) a URL associated with the chart rendering service. The request may be from a computing device of one of a plurality of computational instances disposed within the remote network management platform.

Block 902 may involve, possibly based on the URL, routing, by the chart rendering service, the data to a rendering pipeline.

Block 904 may involve acquiring, by the chart rendering service, a worker thread from a worker thread pool.

Block 906 may involve, possibly based on a pre-determined configuration of the rendering pipeline, the worker thread: (i) rendering the data to a graphical representation of the chart, and (ii) exporting the graphical representation of the chart to an output file and in an output file format.

Block 908 may involve disposing, by the chart rendering service, of the worker thread.

Block 910 may involve transmitting, by the chart rendering service and to the computing device, the output file.

In some embodiments, the URL is one of a plurality of URLs associated with the chart rendering service, the rendering pipeline is one of a plurality of rendering pipelines supported by the chart rendering service, and each of the plurality of URLs is associated with one of the rendering pipelines.

In some embodiments, the data includes an HTML document, the rendering pipeline is an HTML rendering engine, and rendering the data to the graphical representation of the chart involves rendering the HTML document to a web page and applying script resources or cascading style sheet resources to the web page.

Applying the script resources or cascading style sheet resources to the web page may involve: (i) determining one or more file names for the script resources or cascading style sheet resources, (ii) looking up, in a resource cache stored in the central computational instance, the one or more file names, (iii) determining that the one or more file names are in the resource cache, and (iv) obtaining, from the resource cache, the script resources or cascading style sheet resources.

Alternatively, applying the script resources or cascading style sheet resources to the web page may involve: (i) determining one or more file names for the script resources or cascading style sheet resources, (ii) looking up, in a resource cache stored in the central computational instance, the one or more file names, (iii) determining that a particular file name of the one or more file names is not in the resource cache, (iv) retrieving, from the remote network management platform, a particular script resource or particular cascading style sheet resource associated with the particular file name, (v) applying the particular script resource or particular cascading style sheet resource to the web page, (vi) storing, in the resource cache, the particular script resource or particular cascading style sheet resource, and (vii) associating, in the resource cache, the particular file name with the particular script resource or particular cascading style sheet resource.

In some embodiments, the data includes a JSON document, the rendering pipeline includes a third-party module, and rendering the data to the graphical representation of the chart involves: (i) checking whether the third-party module has been loaded, and loading the third-party module if the third-party module has not been loaded, (ii) providing, to the third-party module, the JSON document, and (iii) receiving, from the third-party module, the graphical representation of the chart.

In some embodiments, disposing of the worker thread involves removing the third-party module from memory, and returning the worker thread to the worker thread pool. Alternatively, disposing of the worker thread may involve deleting the data and returning the worker thread to the worker thread pool. In another alternative, disposing of the worker thread may involve destroying the worker thread. In some embodiments, destroying the worker thread is triggered by the worker thread having been used to serve at least a pre-determined threshold number of requests.

Some embodiments may further involve: (i) determining that the data contains an onload command that triggers an onload event to take place after rendering the data, and (ii) before exporting the graphical representation of the chart to the output file, waiting for the onload event to complete.

### VII. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computing system comprising:
a plurality of computational instances of a remote network management platform, each associated with a different managed network; and
a central computational instance of the remote network management platform, wherein the central computational instance provides a chart rendering service to the plurality of computational instances, the chart rendering service configured to:
receive, from a computing device of one of the plurality of computational instances, a request including: (i) data that defines a chart, and (ii) a uniform resource locator (URL) associated with the chart rendering service;
based on the URL, route the data to a rendering pipeline;
acquire a worker thread from a worker thread pool;
based on a pre-determined configuration of the rendering pipeline, the worker thread: (i) rendering the data to a graphical representation of the chart, and (ii) exporting the graphical representation of the chart to an output file and in an output file format;
dispose of the worker thread; and
transmit, to the computing device, the output file.

2. The computing system of claim 1, wherein the URL is one of a plurality of URLs associated with the chart rendering service, wherein the rendering pipeline is one of a plurality of rendering pipelines supported by the chart rendering service, and wherein each of the plurality of URLs is associated with one of the rendering pipelines.

3. The computing system of claim 1, wherein the data includes a hypertext markup language (HTML) document, wherein the rendering pipeline is an HTML rendering engine, and wherein rendering the data to the graphical representation of the chart comprises:
rendering the HTML document to a web page; and
applying, to the web page, any script resources or cascading style sheet resources that are referenced by the HTML document.

4. The computing system of claim 3, wherein applying the script resources or cascading style sheet resources to the web page comprises:
determining one or more file names for the script resources or cascading style sheet resources;
looking up, in a resource cache stored in the central computational instance, the one or more file names;
determining that the one or more file names are in the resource cache; and
obtaining, from the resource cache, the script resources or cascading style sheet resources.

5. The computing system of claim 3, wherein applying the script resources or cascading style sheet resources to the web page comprises:
determining one or more file names for the script resources or cascading style sheet resources;
looking up, in a resource cache stored in the central computational instance, the one or more file names;
determining that a particular file name of the one or more file names is not in the resource cache;
retrieving, from the remote network management platform, a particular script resource or particular cascading style sheet resource associated with the particular file name;
applying the particular script resource or particular cascading style sheet resource to the web page;
storing, in the resource cache, the particular script resource or particular cascading style sheet resource; and
associating, in the resource cache, the particular file name with the particular script resource or particular cascading style sheet resource.

6. The computing system of claim 1, wherein the data includes a JavaScript Object Notation (JSON) document, wherein the rendering pipeline includes a third-party module, and wherein rendering the data to the graphical representation of the chart comprises:
checking whether the third-party module has been loaded, and loading the third-party module if the third-party module has not been loaded;
providing, to the third-party module, the JSON document; and
receiving, from the third-party module, the graphical representation of the chart.

7. The computing system of claim 6, wherein disposing of the worker thread comprises:
removing the third-party module from memory; and
returning the worker thread to the worker thread pool.

8. The computing system of claim 1, wherein disposing of the worker thread comprises deleting the data and returning the worker thread to the worker thread pool.

9. The computing system of claim 1, wherein disposing of the worker thread comprises destroying the worker thread.

10. The computing system of claim 9, wherein destroying the worker thread is triggered by the worker thread having been used to serve at least a pre-determined threshold number of requests.

11. The computing system of claim 1, wherein the chart rendering service is further configured to:
determining that the data contains an onload command that triggers an onload event to take place after rendering the data; and
before exporting the graphical representation of the chart to the output file, waiting for the onload event to complete.

12. A computer-implemented method comprising:
receiving, by a chart rendering service executing on a central computational instance disposed within a remote network management platform, a request including: (i) data that defines a chart, and (ii) a uniform resource locator (URL) associated with the chart rendering service, wherein the request is from a computing device of one of a plurality of computational instances disposed within the remote network management platform;
based on the URL, routing, by the chart rendering service, the data to a rendering pipeline;
acquiring, by the chart rendering service, a worker thread from a worker thread pool;
based on a pre-determined configuration of the rendering pipeline, the worker thread: (i) rendering the data to a graphical representation of the chart, and (ii) exporting the graphical representation of the chart to an output file and in an output file format;
disposing, by the chart rendering service, of the worker thread; and
transmitting, by the chart rendering service and to the computing device, the output file.

13. The computer-implemented method of claim 12, wherein the URL is one of a plurality of URLs associated with the chart rendering service, wherein the rendering pipeline is one of a plurality of rendering pipelines supported by the chart rendering service, and wherein each of the plurality of URLs is associated with one of the rendering pipelines.

14. The computer-implemented method of claim 12, wherein the data includes a hypertext markup language (HTML) document, wherein the rendering pipeline is an HTML rendering engine, and wherein rendering the data to the graphical representation of the chart comprises:
rendering the HTML document to a web page; and
applying script resources or cascading style sheet resources to the web page.

15. The computer-implemented method of claim 14, wherein applying the script resources or cascading style sheet resources to the web page comprises:
determining one or more file names for the script resources or cascading style sheet resources;
looking up, in a resource cache stored in the central computational instance, the one or more file names;
determining that the one or more file names are in the resource cache; and
obtaining, from the resource cache, the script resources or cascading style sheet resources.

16. The computer-implemented method of claim 14, wherein applying the script resources or cascading style sheet resources to the web page comprises:
determining one or more file names for the script resources or cascading style sheet resources;
looking up, in a resource cache stored in the central computational instance, the one or more file names;
determining that a particular file name of the one or more file names is not in the resource cache;
retrieving, from the remote network management platform, a particular script resource or particular cascading style sheet resource associated with the particular file name;
applying the particular script resource or particular cascading style sheet resource to the web page;
storing, in the resource cache, the particular script resource or particular cascading style sheet resource; and
associating, in the resource cache, the particular file name with the particular script resource or particular cascading style sheet resource.

17. The computer-implemented method of claim 12, wherein the data includes a JavaScript Object Notation (JSON) document, wherein the rendering pipeline includes a third-party module, and wherein rendering the data to the graphical representation of the chart comprises:
checking whether the third-party module has been loaded, and loading the third-party module if the third-party module has not been loaded;
providing, to the third-party module, the JSON document; and
receiving, from the third-party module, the graphical representation of the chart.

18. An article of manufacture including a non-transitory computer-readable medium, having stored thereon program instructions that, upon execution by a computing system, cause the computing system to perform operations comprising:
receiving, by a central computational instance disposed within the computing system, a request including: (i) data that defines a chart, and (ii) a uniform resource locator (URL) associated with a chart rendering service, wherein the request is from a computing device of one of a plurality of computational instances disposed within the computing system;
based on the URL, routing the data to a rendering pipeline;
acquiring a worker thread from a worker thread pool;
based on a pre-determined configuration of the rendering pipeline, the worker thread: (i) rendering the data to a graphical representation of the chart, and (ii) exporting the graphical representation of the chart to an output file and in an output file format;
disposing of the worker thread; and
transmitting, to the computing device, the output file.

19. The article of manufacture of claim 18, wherein the data includes a hypertext markup language (HTML) document, wherein the rendering pipeline is an HTML rendering engine, and wherein rendering the data to the graphical representation of the chart comprises:
rendering the HTML document to a web page; and
applying script resources or cascading style sheet resources to the web page.

20. The article of manufacture of claim 18, wherein the data includes a JavaScript Object Notation (JSON) document, wherein the rendering pipeline includes a third-party module, and wherein rendering the data to the graphical representation of the chart comprises:
checking whether the third-party module has been loaded, and loading the third-party module if the third-party module has not been loaded;
providing, to the third-party module, the JSON document; and
receiving, from the third-party module, the graphical representation of the chart.
